(19) United States
(12) Patent Application Publication
(10) Pub. No.: US 2025/0233367 A1
(43) Pub. Date: Jul. 17, 2025

(54) SHIELDING AND INSULATING MODULE WITH SHIELDING-ASSISTING COMPONENT

(71) Applicants: Amphenol East Asia Limited Taiwan Branch (H.K.), New Taipei City (TW); HMT CABLE MANUFACTURING CORPORATION, Shenzhen City (CN)

(72) Inventors: Sheng-Fen SANG, New Taipei City (TW); Ching-Chuan KUNG, Taipei City (TW); Chun-Hao WU, Taipei City (TW)

(21) Appl. No.: 19/012,987

(22) Filed: Jan. 8, 2025

(30) Foreign Application Priority Data
Jan. 12, 2024 (CN) 202420082073.9
Dec. 10, 2024 (TW) 113213603

(51) Int. Cl. H01R 13/6581; H01R 12/71; H01R 13/24; H01R 13/502

(52) U.S. Cl. CPC H01R 13/6581; H01R 12/716; H01R 13/502; H01R 13/24

(57) ABSTRACT

The present invention is a shielding and insulating module with a shielding-assisting component, including an insertion connection insulating component and a shielding-assisting component, wherein the insertion connection insulating component can receive a portion of an electrical connector, and the shielding-assisting component is located at a bottom portion of the insertion connection insulating component so that not only can the complexity in design of the internal structures of the insertion connection insulating component be reduced, but also it is made easy to connect to an external circuit board material or the shielding frames of the electrical connector in order to effectively form an electromagnetic shielding structure for reducing external electromagnetic interference (EMI).

### BACKGROUND OF THE INVENTION

### 1. Technical Field

The present invention relates to an electrically conductive component assembly and more particularly to an electrically conductive component assembly in which an insertion connection insulating component has a bottom portion provided with a shielding-assisting component.

### 2. Description of Related Art

As used herein, the term “connector” refers generally to all the connecting elements that are used to transmit electronic signals and electric power, including their fitting(s), if any. The main function of a connector is to establish and maintain the connection between electrical circuits, and a connector not only is responsible for transmitting electricity, but also covers data transfer, and is therefore an important component of any modern electronic system, which, be it a mobile phone, computer, or large industrial machine, cannot carry out its basic functions without the required connectors.

As their uses and installation locations vary, connectors come in many types that are structurally different in order to adapt to and satisfy user needs. For example, good shielding performance can reduce electromagnetic interference, and emphasis may also be placed on the stability of insertion connection, on durability, on waterproof and dustproof properties, on resistance to vibrations, and so on. It can be known from the above that, as an indispensable component of modern electronic systems, connectors have been evolving in design and application as technological innovations and changes in market demands have taken place. Therefore, how to develop a well-structured connector that can capture market attention is a major issue to be addressed by the present invention.

### BRIEF SUMMARY OF THE INVENTION

In order to stand out in a highly competitive market, the inventor made use of his ample practical experience gained through years devoted to the design, processing, and manufacture of various power or signal connectors, conducted a long-term research and experiment while adhering to the research spirit of pursuing perfection, and finally succeeded in developing a shielding and insulating module with a shielding-assisting component as the present invention, hoping that the invention will receive market attention when made known to the public.

One objective of the present invention is to provide a shielding and insulating module that has a shielding-assisting component. The shielding and insulating module includes: an insertion connection insulating component provided therein with a butt-jointing space, the butt-jointing space being used to receive a portion of an electrical connector; and a shielding-assisting component located at a bottom portion of the insertion connection insulating component, wherein the shielding-assisting component at least includes a main body portion, and the main body portion extends in a transverse-axis or longitudinal-axis direction. Thus, when mounted on a circuit board material, the shielding and insulating module can provide a good grounding path and can contact the shielding frames of an electrical connector so as to form a shielded environment, reducing the degree of crosstalk interference to which the electrically conductive terminals of the electrical connector and the circuit board material are subjected during high-speed signal transmission.

Optionally, the horizontal height of the bottom surface of the main body portion is lower than the horizontal height of the bottom surface of a main portion of the insertion connection insulating component.

Optionally, the shielding-assisting component can be connected to and positioned on the insertion connection insulating component.

Optionally, the insertion connection insulating component is provided therein with a main beam member adjacent to the bottom portion of the insertion connection insulating component, the main beam member extends in the transverse-axis or longitudinal-axis direction, and the bottom surface of the main beam member can lie against the top surface of the main body portion.

Optionally, the shielding-assisting component is provided with at least one shielding-assisting component engaging component, and the shielding-assisting component engaging component can engage with the main beam member.

Optionally, the main body portion has two opposite lateral sides each provided with at least one clamping portion, and each of the clamping portions may be bent and can lie against a lateral surface of the main beam member.

Optionally, the main beam member has two opposite lateral sides each provided with at least one spacer, and the extending direction of the spacers is different from the extending direction of the main beam member.

Optionally, the shielding-assisting component is further provided with at least one rib portion, the extending direction of the rib portion is different from the extending direction of the main body portion, and a top portion of the rib portion can be engaged in the corresponding spacer.

Optionally, the shielding-assisting component is further provided with at least one contact portion, and each of the at least one contact portion is used to abut against a shielding frame of the electrical connector.

Optionally, the rib portion is provided with a plurality of contact portions, at least two of the contact portions are each located on one of opposite lateral sides of the rib portion, and each of the contact portions is used to abut against a different shielding frame of the electrical connector.

Optionally, the shielding and insulating module further includes a board-end insertion connection frame, and the board-end insertion connection frame allows the insertion connection insulating component to be mounted in the board-end insertion connection frame.

Optionally, the shielding-assisting component can be connected to and positioned on the board-end insertion connection frame.

Optionally, the shielding-assisting component is further provided with at least one rib portion, and the extending direction of the rib portion is different from the extending direction of the main body portion.

Optionally, the rib portion is provided with a plurality of contact portions, at least two of the contact portions are each located on one of opposite lateral sides of the rib portion, and each of the contact portions is used to abut against a different shielding frame of the electrical connector.

Another objective of the present invention is to provide a shielding and insulating module that has a shielding-assisting component. The shielding and insulating module includes: an insertion connection insulating component provided therein with a butt-jointing space, the butt-jointing space being used to receive a portion of an electrical connector; and a shielding-assisting component located at a bottom portion of the insertion connection insulating component, wherein the shielding-assisting component at least includes a rib portion, and the rib portion is used to extend into a frame-separating passage between two adjacent shielding frames of the electrical connector.

Optionally, the shielding-assisting component is provided with at least one shielding-assisting component engaging component, and the shielding-assisting component engaging component can engage with the insertion connection insulating component.

Optionally, the shielding-assisting component further includes a main body portion, the main body portion extends in a transverse-axis or longitudinal-axis direction and is connected to each rib portion, and the extending direction of the main body portion is different from the extending direction of each rib portion.

Optionally, the horizontal height of the bottom surface of the main body portion is lower than the horizontal height of the bottom surface of a main portion of the insertion connection insulating component.

Optionally, the insertion connection insulating component is provided therein with a main beam member adjacent to the bottom portion of the insertion connection insulating component, the main beam member extends in the transverse-axis or longitudinal-axis direction, and the bottom surface of the main beam member can lie against the top surface of the main body portion.

To make it easy for the examiner to better know and understand the objectives, technical features, and effects thereof of the present invention, some embodiments are described in detail below with reference to the drawings:

### BRIEF DESCRIPTION OF THE SEVERAL VIEWS OF THE DRAWINGS

FIG. 1 is a schematic perspective view, taken from a first viewing angle, of the electrically conductive component assembly in the first embodiment of the present invention;

FIG. 2 is a schematic perspective view, taken from a second viewing angle, of the electrically conductive component assembly in the first embodiment of the present invention;

FIG. 3 is a schematic perspective view, taken from a first viewing angle, of the insertion connection insulating component in the first embodiment of the present invention;

FIG. 4 is a schematic perspective view of some components of the electrically conductive component assembly in the first embodiment of the present invention;

FIG. 5 is a schematic top view of some components of the electrically conductive component assembly in the first embodiment of the present invention;

FIG. 6 is a schematic perspective view of some components of the electrically conductive component assembly in the first embodiment of the present invention;

FIG. 7 is a schematic side view of some components of the electrically conductive component assembly in the first embodiment of the present invention;

FIG. 8 is a schematic sectional view of the components in FIG. 7 of the electrically conductive component assembly in the first embodiment of the present invention, taken along the line segment;

FIG. 9 is a schematic perspective view, taken from a first viewing angle, of the electrically conductive component assembly in the first embodiment of the present invention;

FIG. 10 is a schematic perspective view, taken from a second viewing angle, of the electrically conductive component assembly in the first embodiment of the present invention;

FIG. 11 is a schematic perspective view, taken from a first viewing angle, of some components of the electrically conductive component assembly in the first embodiment of the present invention;

FIG. 12 is a schematic perspective view, taken from a second viewing angle, of some components of the electrically conductive component assembly in the first embodiment of the present invention;

FIG. 13 is a schematic perspective view of some components of the electrically conductive component assembly in the first embodiment of the present invention;

FIG. 14 is a schematic perspective view of some components of the electrically conductive component assembly in the first embodiment of the present invention;

FIG. 15 is a schematic perspective view of the electrical connector in the first embodiment of the present invention;

FIG. 16 is a schematic perspective view, taken from a first viewing angle, of some components of the electrically conductive component assembly in the first embodiment of the present invention;

FIG. 17 is a schematic perspective view, taken from a second viewing angle, of some components of the electrically conductive component assembly in the first embodiment of the present invention;

FIG. 18 is a schematic perspective view of the electrically conductive component assembly in the first embodiment of the present invention;

FIG. 19 is a schematic perspective view of the electrically conductive component assembly in the first embodiment of the present invention;

FIG. 20 is a schematic front view of the electrically conductive component assembly in the first embodiment of the present invention;

FIG. 21 is a schematic perspective view of some components of the electrically conductive component assembly in the first embodiment of the present invention;

FIG. 22 is a schematic perspective view of the electrically conductive component assembly in the first embodiment of the present invention;

FIG. 23 is a schematic perspective view of the electrically conductive component assembly in the first embodiment of the present invention;

FIG. 24 is a partial sectional perspective view of the shielding and insulating module in the second embodiment of the present invention;

FIG. 25 is a schematic exploded view of the shielding-assisting component in the second embodiment of the present invention;

FIG. 26 is a schematic perspective view, taken from a certain viewing angle, of the shielding-assisting component in the second embodiment of the present invention;

FIG. 27 is a schematic perspective view, taken from another viewing angle, of the shielding-assisting component in the second embodiment of the present invention; and

FIG. 28 is a schematic sectional view of the shielding and insulating module in the second embodiment of the present invention.

### DETAILED DESCRIPTION OF THE INVENTION

To shed more light on the objectives, technical contents, and advantages of the present invention, specific modes of implementation are described below in conjunction with the accompanying drawings. A person of ordinary skill in the art would be able to understand from the following description the advantages and effects of the invention, and the invention can be applied by way of other different embodiments. The details in the present specification can be modified and changed without departing from the concept of the invention. Besides, the accompanying drawings of the invention serve only to provide a simple schematic illustration and are not drawn according to actual dimensions. In addition, unless otherwise specified or defined in the context, the connotations of the terms “a” and “the”/“said” used in relation to the invention include plurality.

It should be understood that the terms used herein generally have their common meanings in the field to which the present invention pertains, and in case of conflict, the definition given herein shall apply. As one thing can be expressed in various ways, the use of an alternative term or synonym does not exclude other synonyms, and all the terms are used for illustrative purposes only, without limiting the scope or meaning of the invention or any term. Terms such as first, second, and third may be used herein to describe various elements, and these terms serve to distinguish one element from another, do not impose any substantial limitation on any element, and do not limit the order in which each element is mounted or disposed in actual use. Besides, directional terms that are mentioned in relation to the embodiments, such as “upper,” “lower,” “front,” “rear,” “left,” and “right,” make reference only to the directions in the accompanying drawings. Therefore, the directional terms used serve to expound, but not to limit, the scope of protection of the invention. Moreover, as used herein, the term “and/or” may include any, or a combination of several, of the associated items listed, depending on the actual condition.

In addition, as used in the present specification, terms such as “substantially” and “approximately” may refer to a value, or the average of multiple values, within a range of deviation from a specific value, wherein the range of deviation is recognized or determined by a person of ordinary skill in the art, taking into consideration a certain error that may be caused by the limitations of the measuring system or equipment used to measure the specific value. For example, a specific value described with “substantially” may include values within ±5%, ±3%, ±1%, ±0.5%, ±0.1%, or one or more standard deviations of the specific value.

The present invention involves an electrically conductive component assembly, and the electrically conductive component assembly provided herein can provide a shielded environment for the abutting joint between electrically conductive terminals and a circuit board material, thereby reducing the degree of crosstalk interference to which the electrically conductive terminals and the circuit board material are subjected during high-speed signal transmission.

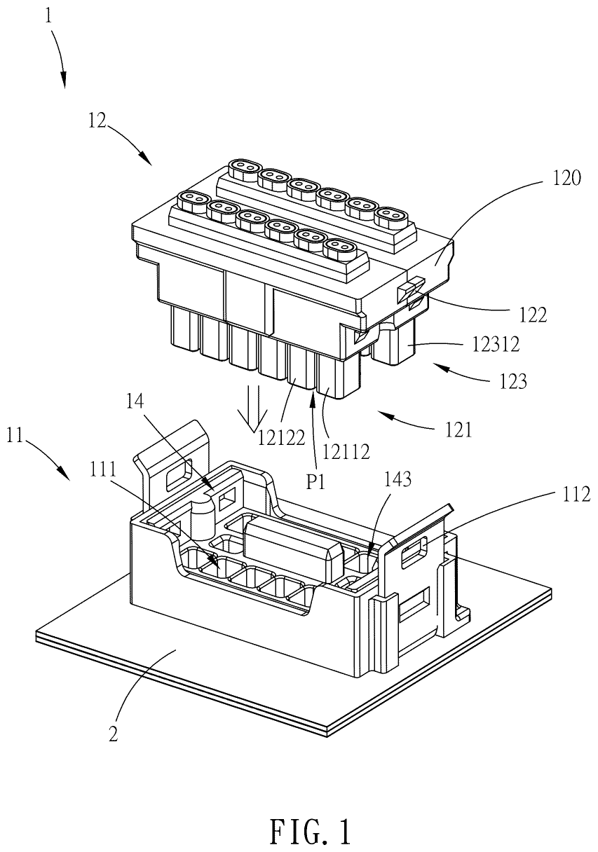

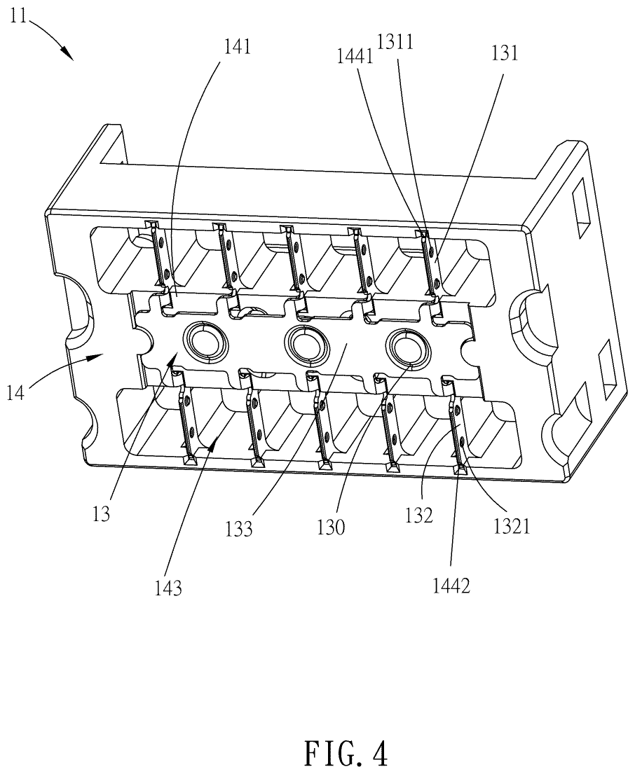

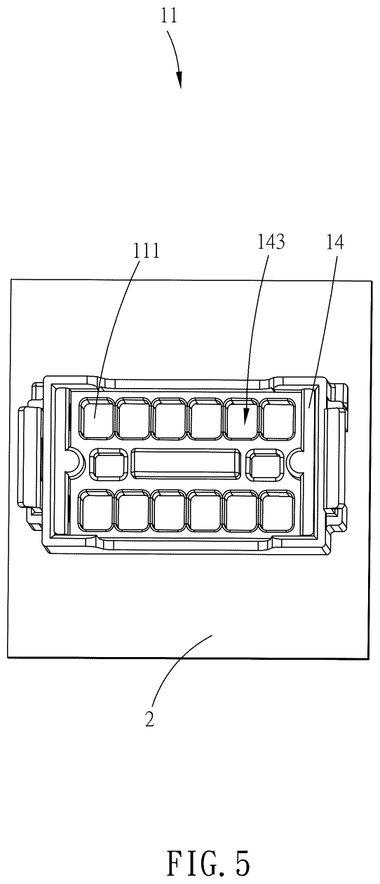

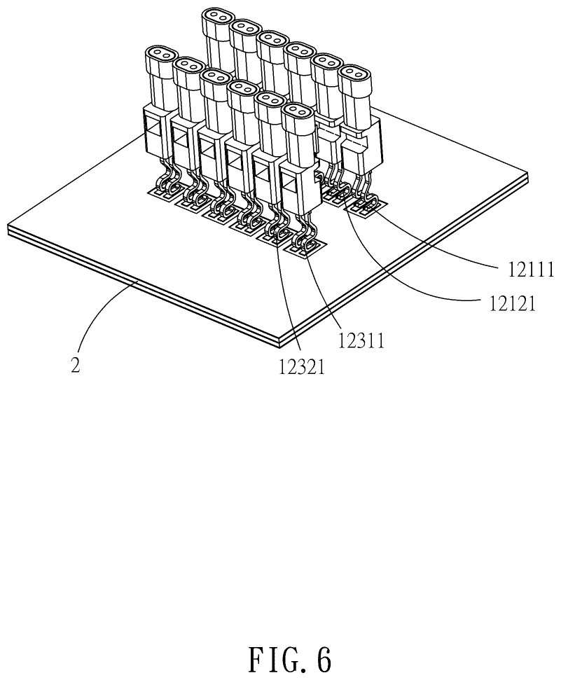

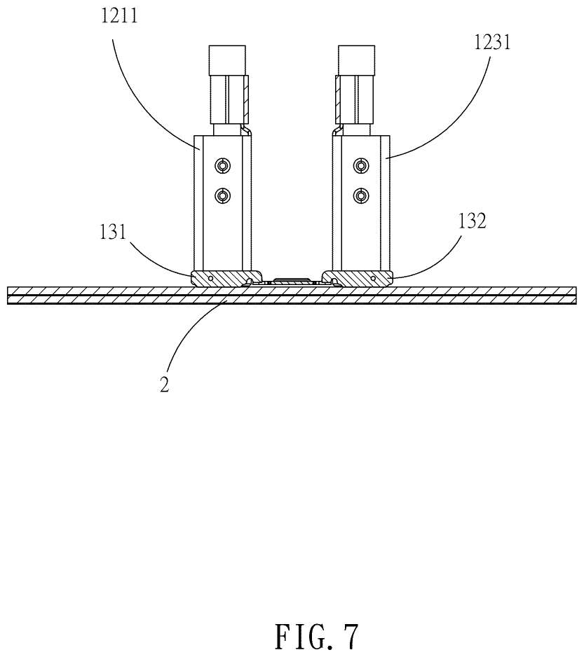

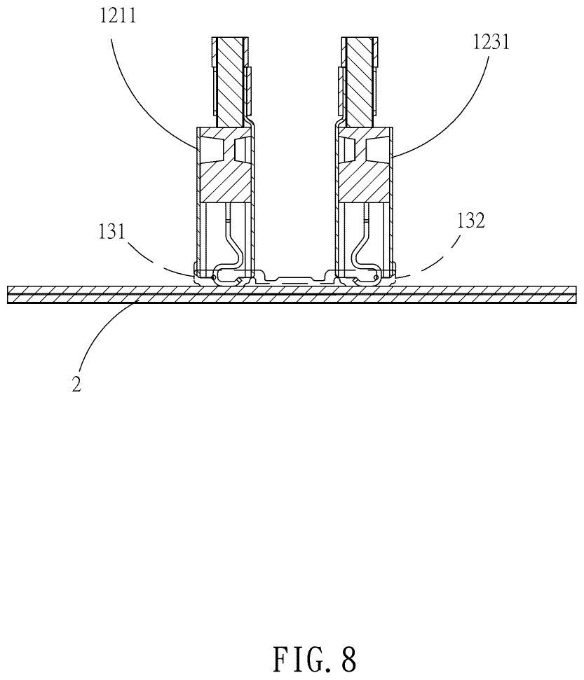

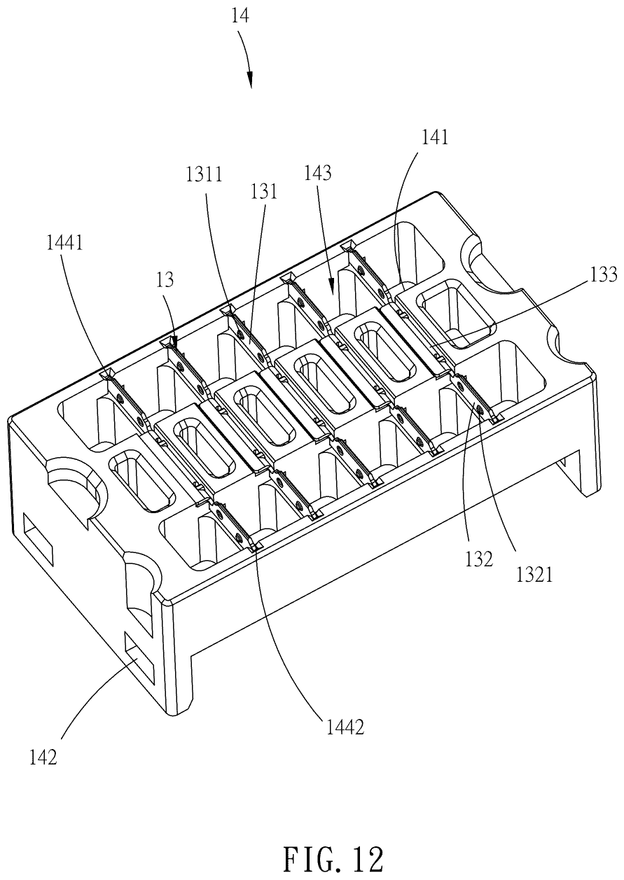

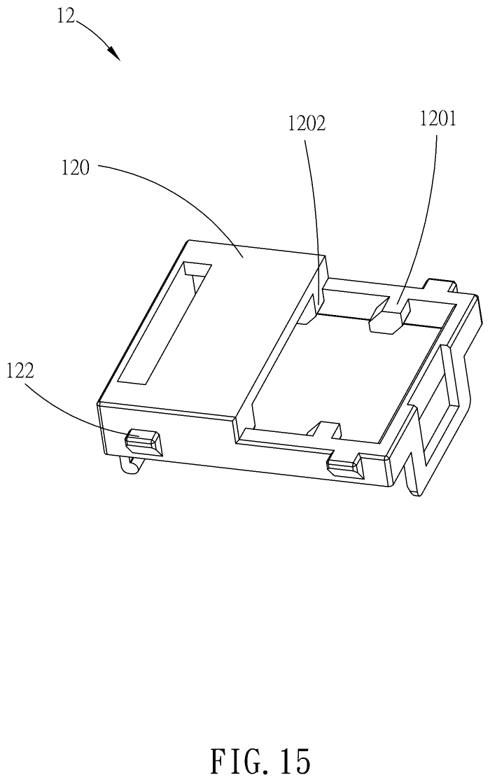

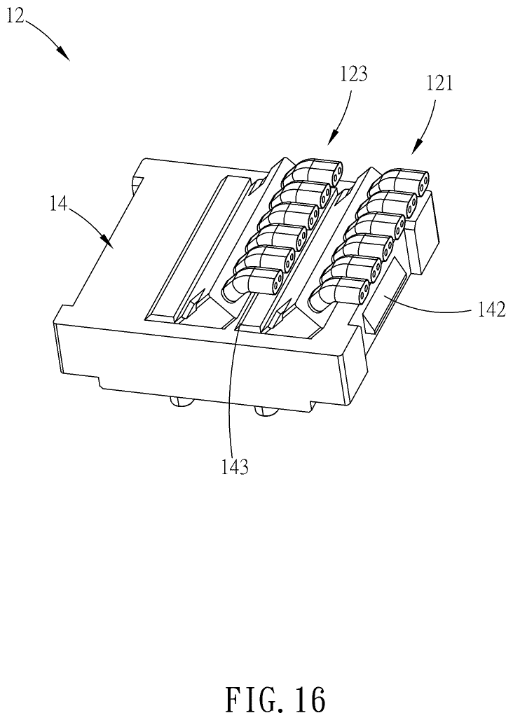

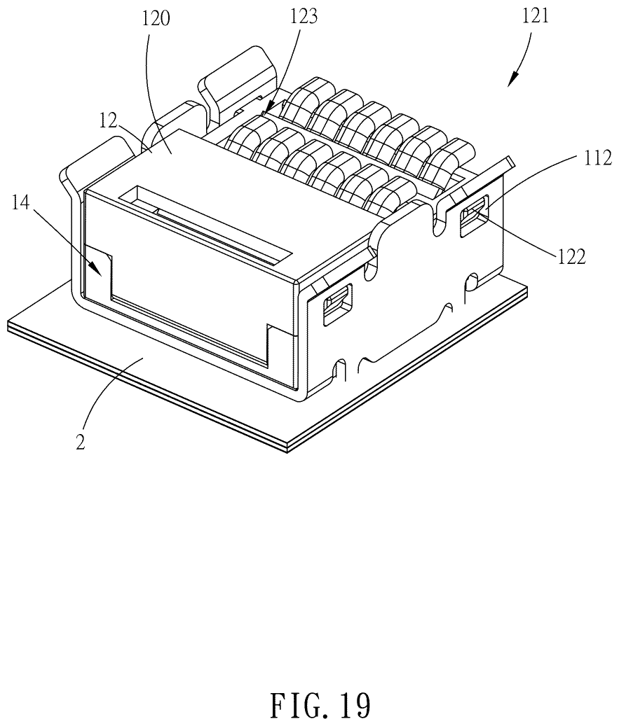

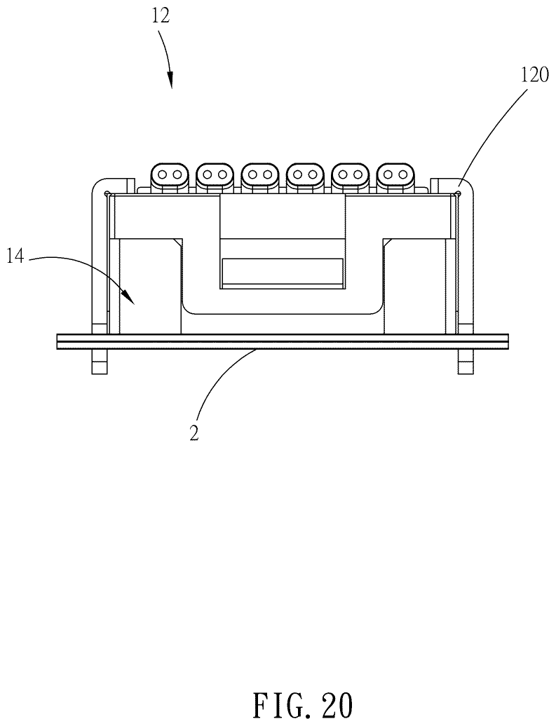

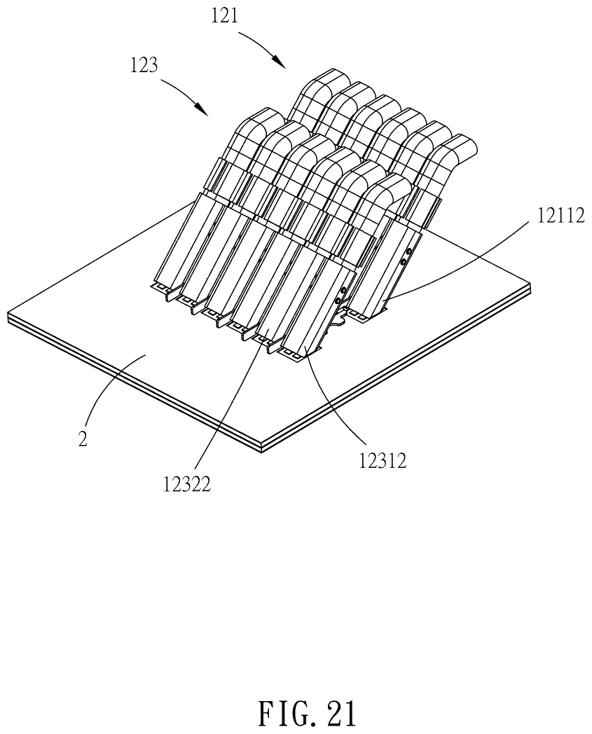

For the technical concept of the electrical connector in the present application, please refer to the description of the first embodiment shown in FIG. 1 to FIG. 23.

The first embodiment shown in FIG. 1 to FIG. 23 discloses an electrically conductive component assembly 1, and the electrically conductive component assembly 1 is used together with a circuit board material 2. The circuit board material 2 is, for example, a circuit board or a flexible circuit board. The electrically conductive component assembly 1 includes: a board-end insertion connection frame 11, an electrical connector 12, a shielding-assisting component 13, and an insertion connection insulating component 14.

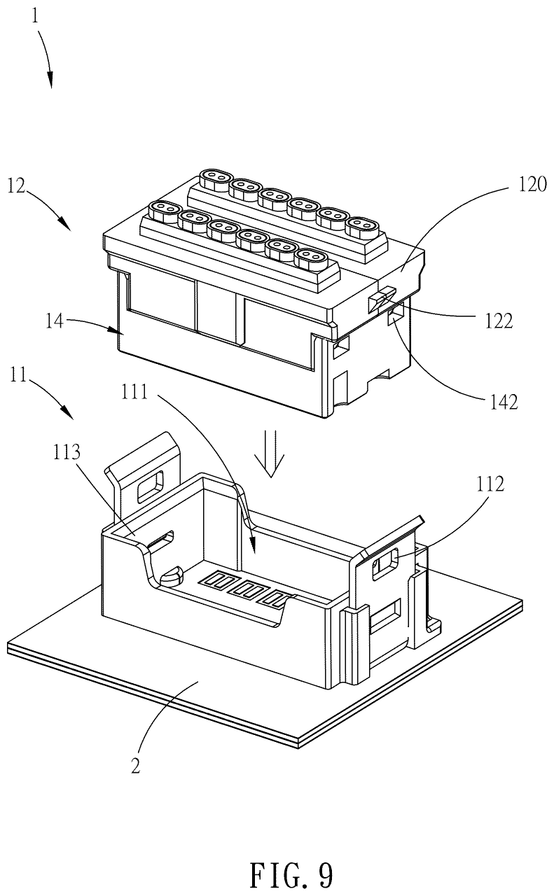

As shown in FIG. 9, the board-end insertion connection frame 11 is positioned on the circuit board material 2, and the board-end insertion connection frame 11 has board-end insertion connection passages 111 and board-end coupling structures 112.

As shown in FIG. 1, the electrical connector 12 has an electrical-connector insulating plastic core 120, a main-side insertion connection component assembly 121, a secondary-side insertion connection component assembly 123, and line-end coupling structures 122. The electrical-connector insulating plastic core 120 keeps the main-side insertion connection component assembly 121 and the secondary-side insertion connection component assembly 123 in position, and the line-end coupling structures 122 are provided at the electrical-connector insulating plastic core 120.

In the foregoing first embodiment, the main-side insertion connection component assembly 121 has at least one first main-side insertion connection component 1211 and at least one second main-side insertion connection component 1212. The first main-side insertion connection component 1211 has first main-side electrically conductive terminals 12111 and a first main-side shielding frame 12112, and the first main-side shielding frame 12112 extends along the sides of the first main-side electrically conductive terminals 12111 in order to shield the first main-side electrically conductive terminals 12111. The second main-side insertion connection component 1212 has second main-side electrically conductive terminals 12121 and a second main-side shielding frame 12122, and the second main-side shielding frame 12122 extends along the sides of the second main-side electrically conductive terminals 12121 in order to shield the second main-side electrically conductive terminals 12121. It should be pointed out that there is a main-side frame-separating passage P1 between the first main-side shielding frame 12112 and the second main-side shielding frame 12122.

In addition, the secondary-side insertion connection component assembly 123 has at least one first secondary-side insertion connection component 1231 and at least one second secondary-side insertion connection component 1232. The first secondary-side insertion connection component 1231 has first secondary-side electrically conductive terminals 12311 and a first secondary-side shielding frame 12312, and the first secondary-side shielding frame 12312 extends along the sides the first secondary-side electrically conductive terminals 12311 in order to shield the first secondary-side electrically conductive terminals 12311. The second secondary-side insertion connection component 1232 has second secondary-side electrically conductive terminals 12321 and a second secondary-side shielding frame 12322, and the second secondary-side shielding frame 12322 extends along the sides of the second secondary-side electrically conductive terminals 12321 in order to shield the second secondary-side electrically conductive terminals 12321. It should be pointed out that there is a secondary-side frame-separating passage P2 between the first secondary-side shielding frame 12312 and the second secondary-side shielding frame 12322.

It should be pointed out that in the foregoing first embodiment, the first main-side shielding frame 12112, the second main-side shielding frame 12122, the first secondary-side shielding frame 12312, and the second secondary-side shielding frame 12322 are in the form of rectangular frames but are not limited to such forms; the first main-side shielding frame 12112, the second main-side shielding frame 12122, the first secondary-side shielding frame 12312, and the second secondary-side shielding frame 12322 may be changed in form to non-rectangular frames according to the implementation conditions.

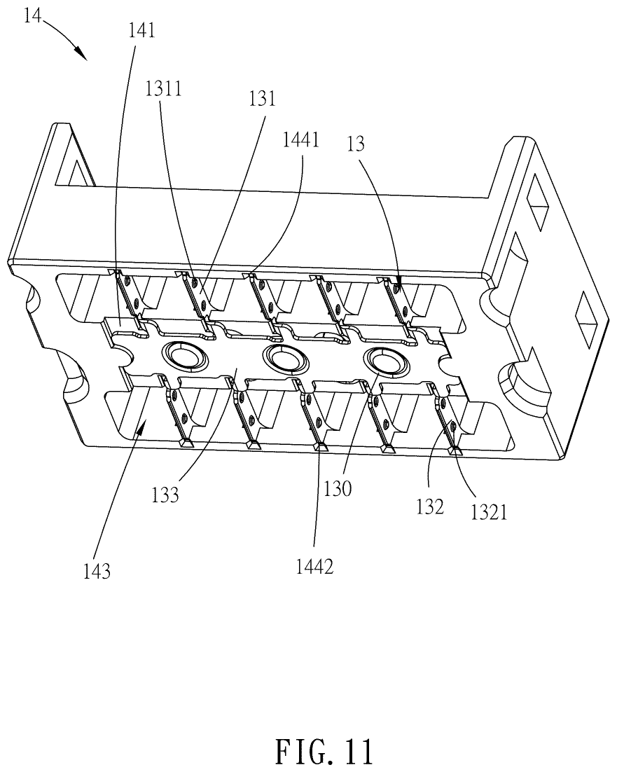

In the first embodiment shown in FIG. 11, the shielding-assisting component 13 has shielding-assisting component engaging components 130, at least a main-side shielding wall 131, and at least a secondary-side shielding wall 132. The shielding-assisting component engaging components 130 are engaged with the insertion connection insulating component 14 (for example and without being limiting, engaged with an insertion connection insulating component pushing structure 141) so that the shielding-assisting component 13 and the insertion connection insulating component 14 can be moved in unison to enter the board-end insertion connection frame 11. The foregoing design, however, is not limiting. In some embodiments, depending on product requirements or production requirements, the insertion connection insulating component 14 itself may have a structure that can be fixed on the circuit board material 2, thereby dispensing with the board-end insertion connection frame 11. Thus, the insertion connection insulating component 14 and the shielding-assisting component 13 can jointly constitute a shielding and insulating module to which the electrical connector 12 can be connected by insertion. Besides, the main-side shielding wall 131 and the secondary-side shielding wall 132 have a main-side shielding wall lap joint structure 1311 and a secondary-side shielding wall lap joint structure 1321 respectively.

In the first embodiment shown in FIG. 9 to FIG. 11, the insertion connection insulating component 14 has the insertion connection insulating component pushing structure 141 and insertion connection insulating component coupling structures 142. The insertion connection insulating component coupling structures 142 may be snap-fit structures (as shown in FIG. 9) or rail structures in order to couple with the electrical connector 12, thereby allowing the insertion connection insulating component 14 and the electrical connector 12 to be moved in unison to enter the board-end insertion connection frame 11.

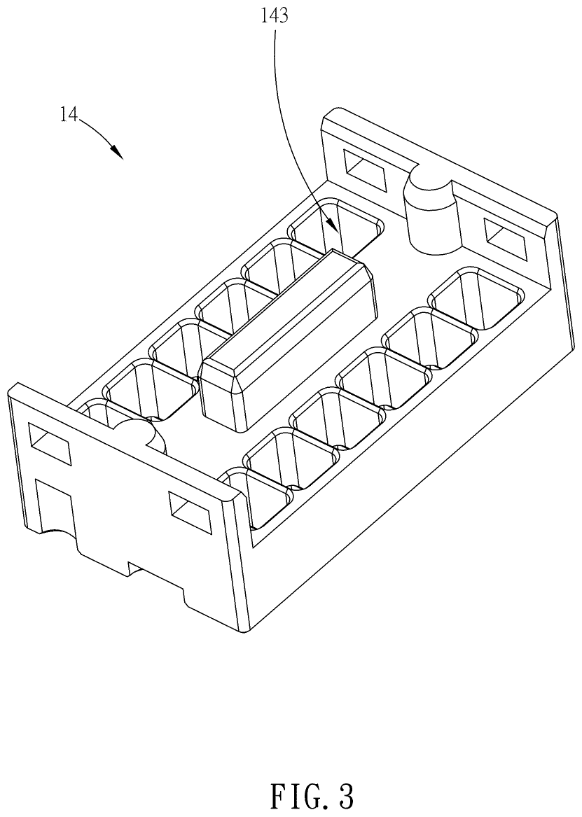

In the foregoing first embodiment, the electrical connector 12 can be inserted into and thereby connected to the board-end insertion connection frame 11 such that the main-side insertion connection component assembly 121 and the secondary-side insertion connection component assembly 123 enter the corresponding insertion connection insulating component insertion connection passages 143 and board-end insertion connection passages 111, with the first main-side electrically conductive terminals 12111, the second main-side electrically conductive terminals 12121, the first secondary-side electrically conductive terminals 12311, and the second secondary-side electrically conductive terminals 12321 abutting against the circuit board material 2 separately so as to transmit electrical signals. It is particularly worth mentioning that, depending on product requirements, the board-end insertion connection frame 11 may have a single insertion connection insulating component insertion connection passage 143 or multiple insertion connection insulating component insertion connection passages 143; for example, the multiple insertion connection insulating component insertion connection passages 143 in FIG. 3 may be made to communicate with one another (i.e., by removing the wall between each two adjacent insertion connection insulating component insertion connection passages 143) and thus form one insertion connection insulating component insertion connection passage 143.

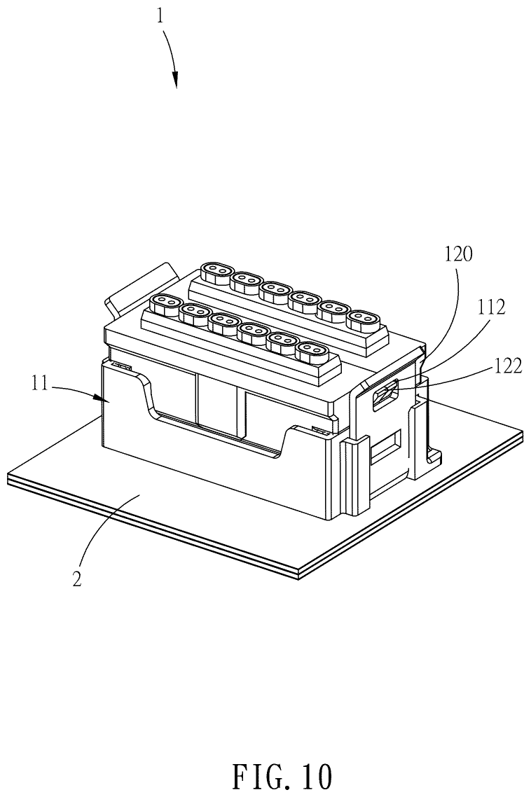

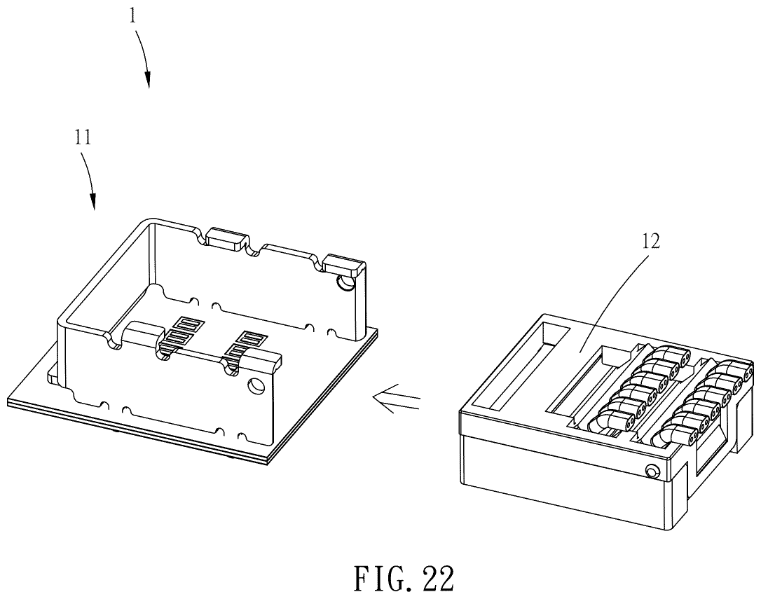

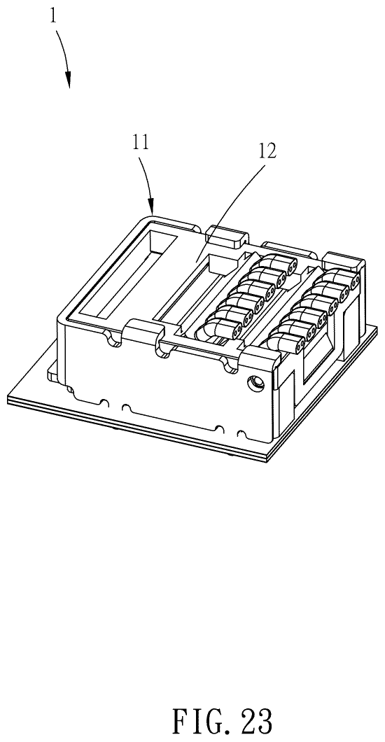

It should be pointed out that in the present application, the electrical connector 12 may be inserted into and thereby connected to the board-end insertion connection frame 11 in a longitudinal direction (as shown in FIG. 9 to FIG. 10) or be inserted into and thereby connected to the board-end insertion connection frame 11 in a transverse direction (as shown in FIG. 22 to FIG. 23).

Optionally, the first main-side electrically conductive terminals 12111, the second main-side electrically conductive terminals 12121, the first secondary-side electrically conductive terminals 12311, and the second secondary-side electrically conductive terminals 12321 may each have a pin structure for abutting against the circuit board material 2 elastically, thereby solving the technical problem that the first main-side electrically conductive terminals 12111, the second main-side electrically conductive terminals 12121, the first secondary-side electrically conductive terminals 12311, and the second secondary-side electrically conductive terminals 12321 fail to abut against the circuit board material 2 effectively, and allowing the first main-side electrically conductive terminals 12111, the second main-side electrically conductive terminals 12121, the first secondary-side electrically conductive terminals 12311, the second secondary-side electrically conductive terminals 12321, and the circuit board material 2 to constitute a signal transmission circuit for transmitting electrical signals in electronic equipment.

In the foregoing first embodiment, when the electrical connector 12 is inserted into and thereby connected to the board-end insertion connection frame 11, the line-end coupling structures 122 can couple with the board-end coupling structures 112 such that the electrical connector 12 actuates the shielding-assisting component 13 via the insertion connection insulating component 14, with the insertion connection insulating component pushing structure 141 pushing the shielding-assisting component 13 into abutment against the circuit board material 2, causing elastic deformation of a portion of the extending sections of the shielding-assisting component 13; as a result, a portion of the main-side shielding wall 131 and a portion of the secondary-side shielding wall 132 enter the main-side frame-separating passage P1 and the secondary-side frame-separating passage P2 respectively, making not only the main-side shielding wall lap joint structure 1311 form a lap joint with the first main-side shielding frame 12112 and with the second main-side shielding frame 12122 in the main-side frame-separating passage P1 such that the main-side shielding wall 131, the first main-side shielding frame 12112, and the second main-side shielding frame 12122 are electrically connected and constitute a main-side shielding conductor B1 for transmitting a shielding signal, but also the secondary-side shielding wall lap joint structure 1321 form a lap joint with the first secondary-side shielding frame 12312 and with the second secondary-side shielding frame 12322 in the secondary-side frame-separating passage P2 such that the secondary-side shielding wall 132, the first secondary-side shielding frame 12312, and the second secondary-side shielding frame 12322 are electrically connected and constitute a secondary-side shielding conductor B2 for transmitting a shielding signal.

In addition, when the aforesaid portion of the extending sections of the shielding-assisting component 13 is elastically deformed, another portion of the main-side shielding wall 131 and another portion of the secondary-side shielding wall 132 can abut against the circuit board material 2 separately such that the main-side shielding wall 131 shields the gap between the first main-side shielding frame 12112 and the circuit board material 2, with the main-side shielding wall 131 and the first main-side shielding frame 12112 providing a shielded environment for the abutment between the first main-side electrically conductive terminals 12111 and the circuit board material 2, thus reducing the degree of crosstalk interference to which the electrically conductive terminals and the circuit board material are subjected during high-speed signal transmission. Moreover, the secondary-side shielding wall 132 can shield the gap between the first secondary-side shielding frame 12312 and the circuit board material 2, with the secondary-side shielding wall 132 and the first secondary-side shielding frame 12312 providing a shielded environment for the abutment between the first secondary-side electrically conductive terminals 12311 and the circuit board material 2, thus reducing the degree of crosstalk interference to which the electrically conductive terminals and the circuit board material are subjected during high-speed signal transmission.

Similarly, when the aforesaid another portion of the main-side shielding wall 131 and the aforesaid another portion of the secondary-side shielding wall 132 abut against the circuit board material 2, the main-side shielding wall 131 can shield the gap between the second main-side shielding frame 12122 and the circuit board material 2, with the main-side shielding wall 131 and the second main-side shielding frame 12122 providing a shielded environment for the abutment between the second main-side electrically conductive terminals 12121 and the circuit board material 2, thus reducing the degree of crosstalk interference to which the electrically conductive terminals and the circuit board material are subjected during high-speed signal transmission. Moreover, the secondary-side shielding wall 132 can further shield the gap between the second secondary-side shielding frame 12322 and the circuit board material 2, with the secondary-side shielding wall 132 and the second secondary-side shielding frame 12322 providing a shielded environment for the abutment between the second secondary-side electrically conductive terminals 12321 and the circuit board material 2, thus reducing the degree of crosstalk interference to which the electrically conductive terminals and the circuit board material are subjected during high-speed signal transmission.

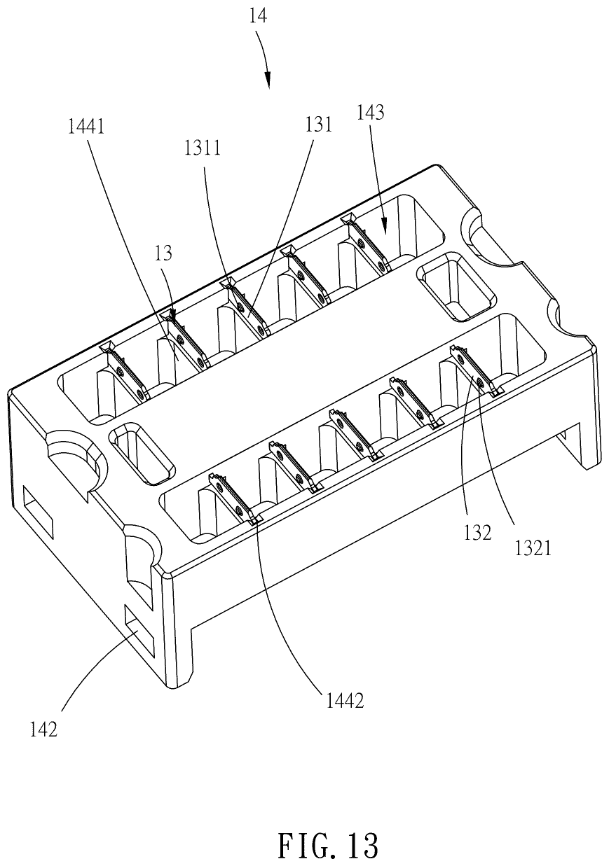

In the first embodiment shown in FIG. 13, the insertion connection insulating component 14 has an insertion connection insulating component main-side guiding structures 1441 and an insertion connection insulating component secondary-side guiding structure 1442, such as grooves. The insertion connection insulating component main-side guiding structure 1441 and the insertion connection insulating component secondary-side guiding structure 1442 can guide the main-side shielding wall 131 and the secondary-side shielding wall 132 respectively in order for the main-side shielding wall 131 and the secondary-side shielding wall 132 to enter the main-side frame-separating passage P1 and the secondary-side frame-separating passage P2 respectively, and for the main-side shielding wall 131 and the secondary-side shielding wall 132 to abut against the circuit board material 2 separately.

It should be pointed out that the board-end coupling structures 112 and the line-end coupling structures 122 can interfere with separation of the electrical connector 12 from the board-end insertion connection frame 11; that the board-end coupling structures 112 and the line-end coupling structures 122 are, but are not limited to, the snap-fit structures shown in FIG. 1; and that the board-end coupling structures 112 and the line-end coupling structures 122 may alternatively use ways other than a snap-fit, such as the rail structures shown in FIG. 22, to interfere with separation of the electrical connector 12 from the board-end insertion connection frame 11.

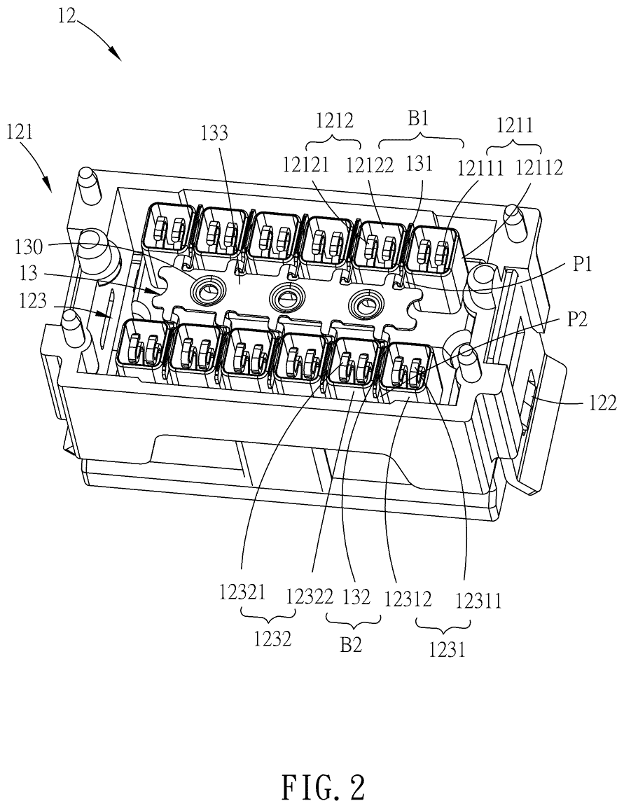

As shown in FIG. 2, the shielding-assisting component 13 further has a shielding joining body 133; the shielding joining body 133 joins the main-side shielding wall 131 and the secondary-side shielding wall 132 such that the main-side shielding conductor B1 and the secondary-side shielding conductor B2 are electrically connected; and the insertion connection insulating component pushing structure 141 pushes the shielding joining body 133 and thereby makes the shielding-assisting component 13 abut against the circuit board material 2, resulting in elastic deformation of the aforesaid portion of the extending sections of the shielding-assisting component 13.

In the first embodiment shown in FIG. 9, the board-end insertion connection frame 11 further has a board-end placement structure 113, and the board-end placement structure 113 is where the shielding-assisting component 13 and the insertion connection insulating component 14 are placed so that the electrical connector 12 can actuate the shielding-assisting component 13 via the insertion connection insulating component 14 while in the board-end insertion connection frame 11.

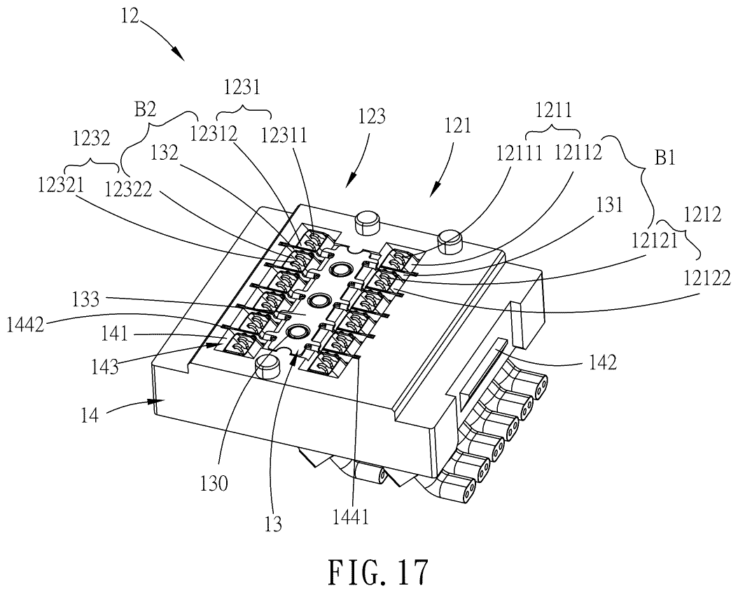

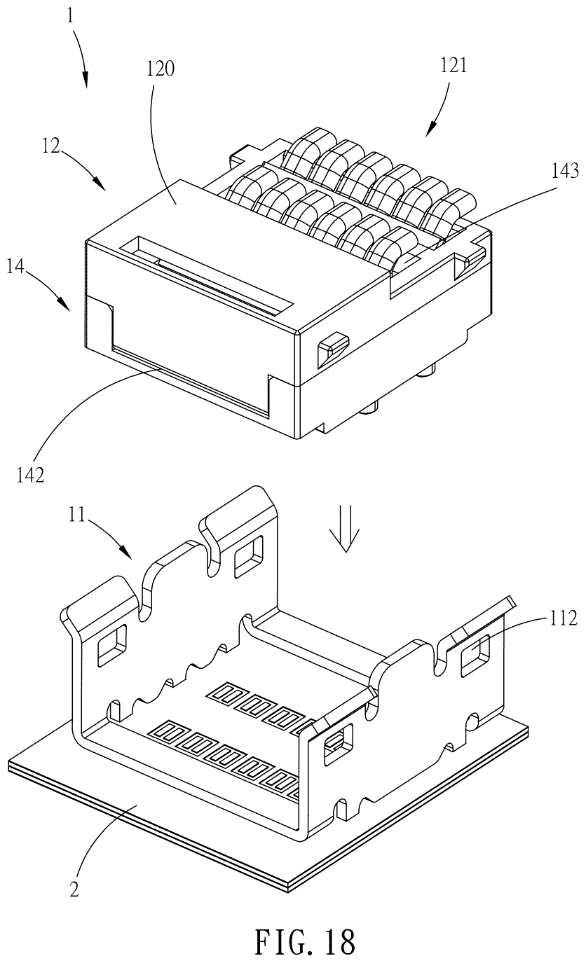

In the first embodiment shown in FIG. 17 to FIG. 18, the insertion connection insulating component 14 further has insertion connection insulating component insertion connection passages 143 that extend slantingly so that the main-side insertion connection component assembly 121 and the secondary-side insertion connection component assembly 123 can enter the insertion connection insulating component insertion connection passages 143 separately and connect to the circuit board material 2 while being inserted slantingly. However, the foregoing design is not limiting. Alternatively, in the first embodiment shown in FIG. 1, the insertion connection insulating component insertion connection passages 143 extend in a longitudinal direction so that the main-side insertion connection component assembly 121 can enter the insertion connection insulating component insertion connection passages 143 separately and connect to the circuit board material 2 while being inserted in the longitudinal direction.

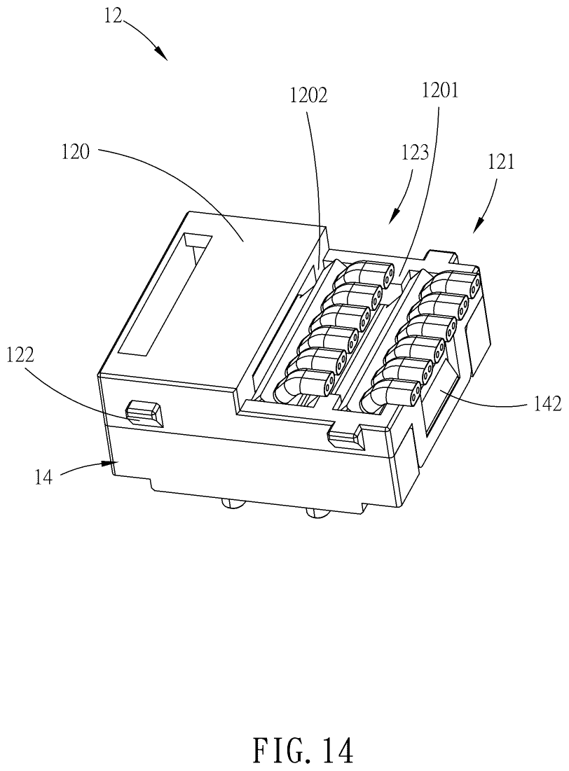

In addition, as shown in FIG. 14 to FIG. 18, the electrical connector insulating plastic core 120 further has a main-side insertion connection component positioning structure 1201 and a secondary-side insertion connection component positioning structure 1202, and the main-side insertion connection component positioning structure 1201 and the secondary-side insertion connection component positioning structure 1202 keep the main-side insertion connection component assembly 121 and the secondary-side insertion connection component assembly 123 in position respectively (e.g., by being engaged with the main-side insertion connection component assembly 121 and the secondary-side insertion connection component assembly 123 respectively), lest the main-side insertion connection component assembly 121 and the secondary-side insertion connection component assembly 123 leave the insertion connection insulating component insertion connection passages 143 easily.

It should be pointed out that the electrically conductive component assembly in the present application may omit some of the components described above and is not limited to the foregoing first embodiment.

For example, the electrically conductive component assembly in the present application may alternatively include: a board-end insertion connection frame, an electrical connector, a shielding-assisting component, and an insertion connection insulating component. The board-end insertion connection frame is positioned on a circuit board material, and the board-end insertion connection frame has board-end insertion connection passages and board-end coupling structures. The electrical connector has a main-side insertion connection component assembly and line-end coupling structures; the main-side insertion connection component assembly has at least one first main-side insertion connection component and at least one second main-side insertion connection component; the first main-side insertion connection component has first main-side electrically conductive terminals and a first main-side shielding frame, with the first main-side shielding frame extending along the sides of the first main-side electrically conductive terminals; and the second main-side insertion connection component has at least one second main-side electrically conductive terminal and at least one second main-side shielding frame, with the second main-side shielding frame extending along the sides of the second main-side electrically conductive terminal, wherein there is a main-side frame-separating passage between the first main-side shielding frame and the second main-side shielding frame. The shielding-assisting component has at least one main-side shielding wall, and the main-side shielding wall has a main-side shielding wall lap joint structure. The insertion connection insulating component has an insertion connection insulating component pushing structure.

It should be pointed out that the electrical connector can be inserted into and thereby connected to the board-end insertion connection frame such that the main-side insertion connection component assembly enters the insertion connection insulating component insertion connection passages and the board-end insertion connection passages, thereby allowing the first main-side electrically conductive terminals and the second main-side electrically conductive terminal to abut against the circuit board material separately; and that when the electrical connector is inserted into and thereby connected to the board-end insertion connection frame, the line-end coupling structures can couple with the board-end coupling structures such that the electrical connector actuates the shielding-assisting component via the insertion connection insulating component, with the insertion connection insulating component pushing structure pushing the shielding-assisting component into abutment against the circuit board material, causing elastic deformation of a portion of the extending sections of the shielding-assisting component; as a result, the main-side shielding wall enters the main-side frame-separating passage, making the main-side shielding wall lap joint structure form a lap joint with the first main-side shielding frame and with the second main-side shielding frame such that: the main-side shielding wall, the first main-side shielding frame, and the second main-side shielding frame are electrically connected and constitute a main-side shielding conductor; the main-side shielding wall shields the gap between the first main-side shielding frame and the circuit board material, and in consequence the main-side shielding wall and the first main-side shielding frame provide a shielded environment for the abutment between the first main-side electrically conductive terminals and the circuit board material; and the main-side shielding wall also shields the gap between the second main-side shielding frame and the circuit board material, and in consequence the main-side shielding wall and the second main-side shielding frame provide a shielded environment for the abutment between the second main-side electrically conductive terminal and the circuit board material.

In summary of the above, the present application provides an electrically conductive component assembly; the electrically conductive component assembly can be used together with a circuit board material; the electrical connector has electrically conductive terminals, shielding frames, and shielding walls; the electrically conductive terminals can abut against the circuit board material in order to transmit electrical signals; the shielding walls can abut against the shielding frames such that the shielding walls and the shielding frames are electrically connected and constitute shielding conductors for transmitting a shielding signal; and the shielding walls can abut against the circuit board material, with the shielding walls shielding the gaps between the shielding frames and the circuit board material, and hence with the shielding walls and the main-side shielding frame providing a shielded environment for the abutment between the electrically conductive terminals and the circuit board material.

In the first embodiment, as shown in FIG. 11, the shielding-assisting component 13 is integrally formed of the main-side shielding wall 131, the secondary-side shielding wall 132, and the shielding joining body 133 and is fixed on the insertion connection insulating component 14 through the shielding-assisting component engaging components 130, but the foregoing is not limiting. The structures of the insertion connection insulating component and of the shielding-assisting component can be changed according to design requirements and are not restricted to the specific structures in the first embodiment. In the second embodiment, several variant configurations of the shielding-assisting component are disclosed, and some of the essential elements are renamed, restated, and renumbered as needed for description while the remaining elements, which are identical or similar to their counterparts in the first embodiment and whose details can be known by referring to the first embodiment, are not described repeatedly.

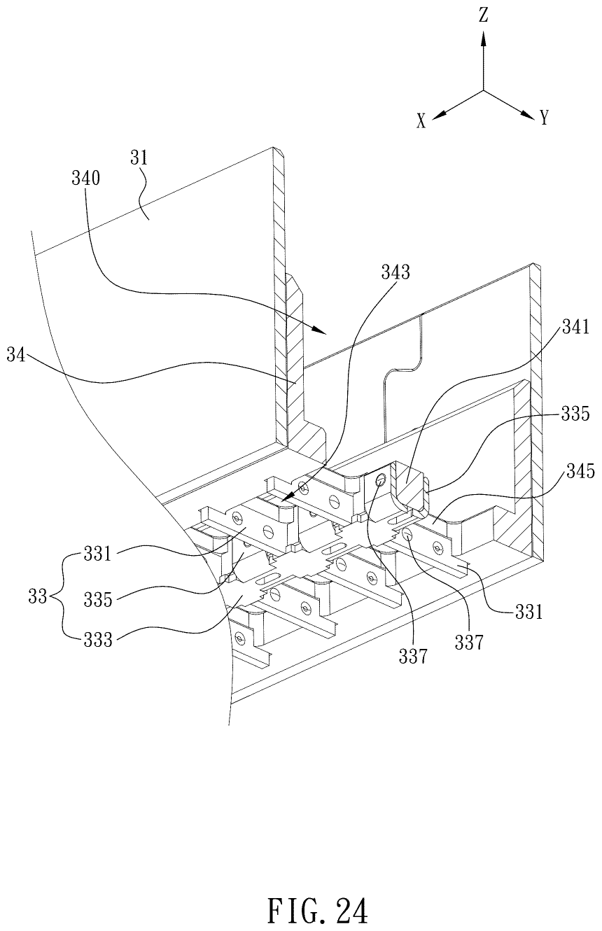

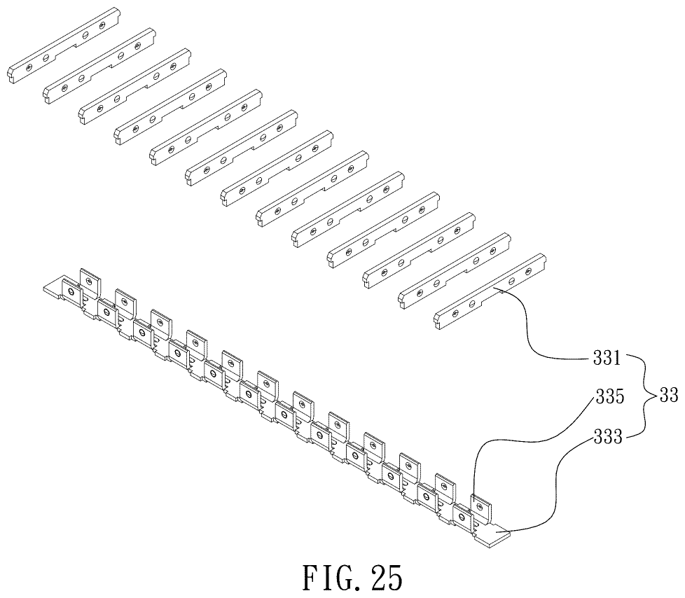

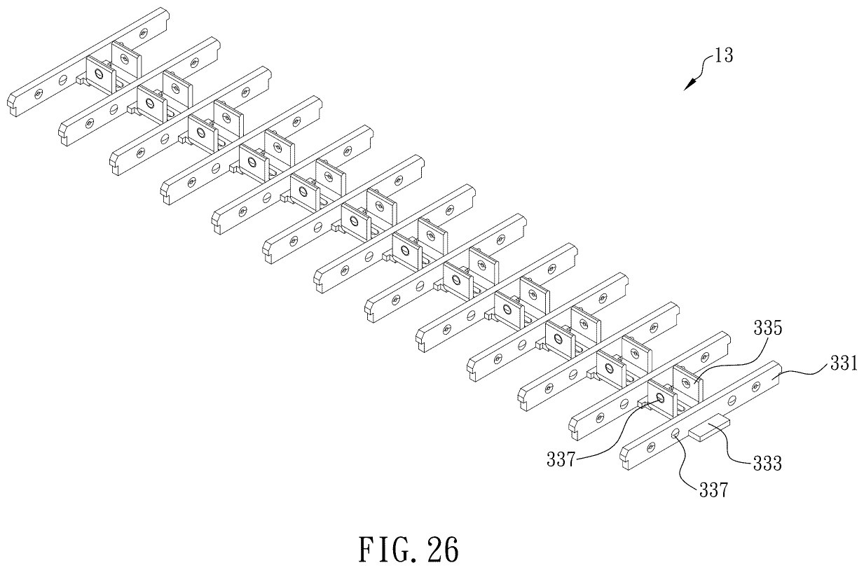

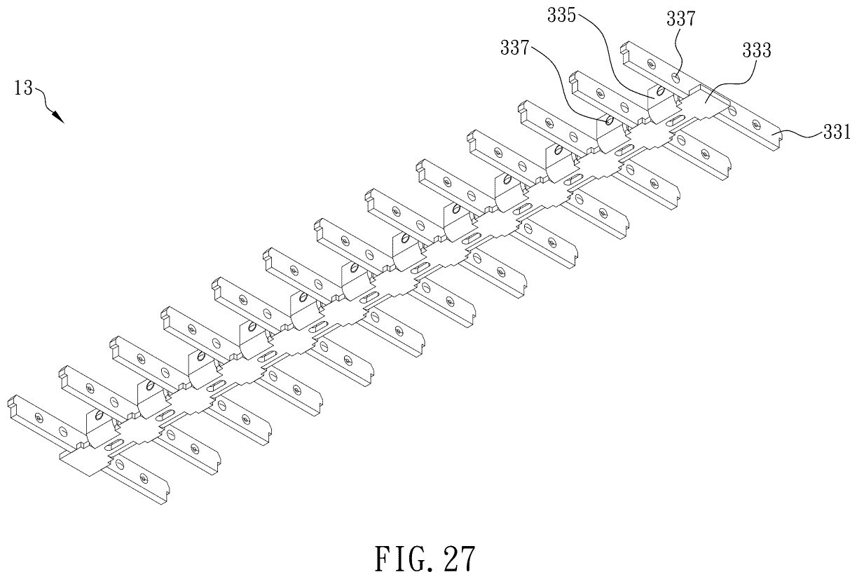

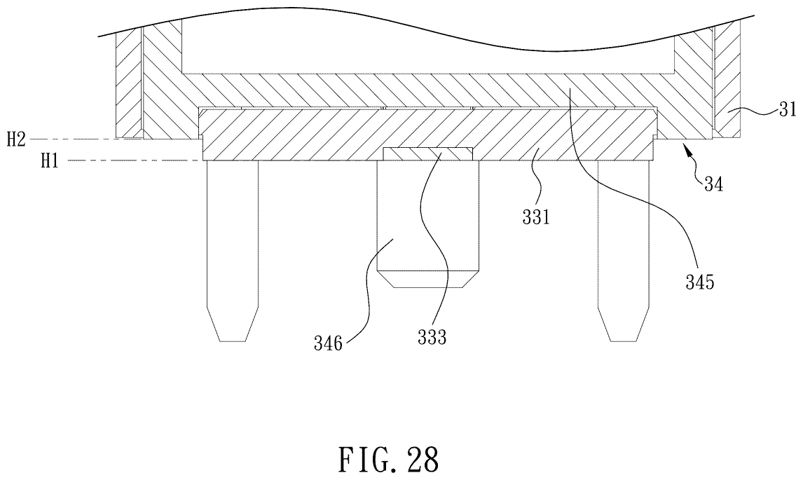

Referring to FIG. 24 to FIG. 27, in the second embodiment, the shielding-assisting component 33 at least includes a main body portion 333, and the main body portion 333 may extend in a transverse-axis (X-axis) direction but is not limited to extending in this direction; depending on product or design requirements, the main body portion 333 may extend in a longitudinal-axis (Y-axis) direction instead. In addition, the horizontal height H1 of the bottom surface of the main body portion 333 is lower than the horizontal height H2 of the bottom surface of a main portion of the insertion connection insulating component 34 (as shown in FIG. 28). It should be pointed out that the “main portion” of the insertion connection insulating component 34 refers to a structural portion that is directly related to the peripheral sidewalls; in other words, the main portion is equivalent to a core region supporting the butt-jointing space 340 surrounded by the peripheral sidewalls and does not include accessory structures to be fixed to a circuit board or other extension designs. The butt-jointing space 340 allows a portion of an electrical connector to extend into the butt-jointing space 340. For example, one of the sidewalls of the insertion connection insulating component 34 may be provided with a positioning post 346, and the positioning post 346 can be used to fix the insertion connection insulating component 34 on a circuit board. The positioning post 346 can be viewed as an accessory structure of the insertion connection insulating component 34 that is used to be fixed to a circuit board; therefore, the positioning post 346 does not belong to the “main portion” of the insertion connection insulating component 34.

Moreover, depending on product or production requirements, the shielding-assisting component 33 may be connected to and positioned at the insertion connection insulating component 34 or be connected to and positioned at the board-end insertion connection frame 31. More specifically, referring again to FIG. 24 to FIG. 28, in the second embodiment, the shielding-assisting component 33 is connected to and positioned on the insertion connection insulating component 34. The insertion connection insulating component 34 is provided therein with a main beam member 341 adjacent to a bottom portion of the insertion connection insulating component 34, and the main beam member 341 extends in the transverse-axis (X-axis) direction but is not limited to extending in this direction; in other embodiments of the present invention, the main beam member 341 may extend in the longitudinal-axis (Y-axis) direction instead. In addition, the bottom surface of the main beam member 341 can be in close contact with the top surface of the main body portion 333, the main beam member 341 has two opposite lateral sides each provided with at least one spacer 345, and the extending direction of the spacers 345 is different from the extending direction of the main beam member 341. In the second embodiment, the spacers 345 are substantially perpendicular to the main beam member 341 and form a plurality of insertion connection insulating component insertion connection passages 343 by division.

Continued from the above, referring to FIG. 24 to FIG. 28, the main body portion 333 has two opposite lateral sides each provided with at least one clamping portion 335, and each clamping portion 335 may be bent upward and can lie against the corresponding lateral side of the main beam member 341 such that the shielding-assisting component 33 is securely clamped to, thereby fixed on, the main beam member 341. However, the design of the present invention is not limited to the foregoing clamping method. In other embodiments of the invention, the shielding-assisting component 33 may be mounted on the main beam member 341 or the spacers 345 through mechanical engagement or by other fixing methods; or the insertion connection insulating component 34 may dispense with the main beam member 341 and/or the spacers 345, and the shielding-assisting component 33 may be positioned at another portion of the insertion connection insulating component 34 (e.g., the peripheral sidewalls of the insertion connection insulating component 34); or the shielding-assisting component 33 may be an independent element mounted on the board-end insertion connection frame 31; or the shielding-assisting component 33 may be integrally formed on the board-end insertion connection frame 31; or the shielding-assisting component 33 may be connected to and positioned on both the insertion connection insulating component 34 and the board-end insertion connection frame 31 (e.g., the shielding-assisting component 33 may have the clamping portions 335 and can be mounted on the board-end insertion connection frame 31). Thus, depending on product or production requirements, the mounting structure of the shielding-assisting component 33 can be flexibly adjusted. Besides, in this embodiment, the clamping portions 335 are integrally formed on the main body portion 333 but are not necessarily so; in some embodiments, the clamping portions 335 may be independent elements mounted on the main body portions 333.

Referring again to FIG. 24 to FIG. 28, the shielding-assisting component 33 is further provided with at least one rib portion 331, and the extending direction of the rib portions 331 is different from the extending direction of the main body portion 333. In the second embodiment, the rib portions 331 are substantially perpendicular to the main body portion 333, and a top portion of each rib portion 331 can be engaged in the corresponding spacer 345 to effectively increase the structural strength and stability of the spacers 345. In addition, depending on product or production requirements, the rib portions 331 may be independent elements mounted on the main body portion 333, or the rib potions 331 may be integrally formed on the main body portion 333 (as in the configuration in the first embodiment). Besides, the shielding-assisting component 33 is further provided with at least one contact portion 337, and the contact portions 337 are equivalent in function to the main-side shielding wall lap joint structure and the secondary-side shielding wall lap joint structure in the first embodiment and can each abut against the corresponding shielding frame on the electrical connector (e.g., the first main-side shielding frame, the second main-side shielding frame, the first secondary-side shielding frame, or the second secondary-side shielding frame) so as to constitute a shielding conductor (e.g., the main-side shielding conductor or the secondary-side shielding conductor) for transmitting a shielding signal. Furthermore, when the shielding frames are electrically connected to a grounding circuit and serve as a grounding path, the connection relationships of the contact portions 337 contribute to the formation of a low-impedance grounding loop that can guide stray current away effectively to reduce the risk of poor grounding. It is particularly worth mentioning that in the second embodiment, each single rib portion 331 is connected to the main body portion 333 in such a way that the two ends of the rib portion 331 are each disposed on one of the two opposite lateral sides of the main body portion 333; however, this configuration is not limiting. Depending on product or production requirements, a single rib portion 331 may be located on only one of the two lateral sides of the main body portion 333.

Continued from the above, referring again to FIG. 24 to FIG. 28, depending on product requirements, the contact portions 337 may be in the form of protruding dots and may be provided on the clamping portions 335 and/or the rib portions 331. In the second embodiment, the two opposite lateral sides of each rib portion 331 may each be provided with at least one contact portion 337, and each contact portion 337 can abut against the corresponding shielding frame on the electrical connector. Thus, with the shielding-assisting component 33 located at a bottom portion of the insertion connection insulating component 34, the complexity in design of the internal structures of the insertion connection insulating component 34 can be reduced, and it is made easy to connect to an external grounding element or grounding circuit in order to form an effective electromagnetic shielding structure for reducing external electromagnetic interference (EMI).

It should be pointed out that the present invention provides two different modes of implementation of the insertion connection insulating component and of the shielding-assisting component. Therefore, although some of the elements in the two embodiments are named and described differently to clearly show the technical features of each embodiment, those elements should be viewed as equivalent elements in the technical field to which the invention pertains; that is to say, despite their different names, they are consistent in function or at least capable of achieving identical or similar technical effects. For example, the “main body portion” in the second embodiment corresponds to the “shielding joining body” in the first embodiment, the “rib portion” in the second embodiment corresponds to the “main-side shielding wall” and “secondary-side shielding wall” in the first embodiment, the “contact portion” in the second embodiment corresponds to the “main-side shielding wall lap joint structure” and “secondary-side shielding wall lap joint structure” in the first embodiment, and the “main beam member” in the second embodiment corresponds to the “insertion connection insulating component pushing structure” in the first embodiment.

The foregoing description is directed to only some preferred embodiments of the present invention; however, the scope of the claims of the invention is not limited to those embodiments. Any equivalent change that is based on the technical contents disclosed herein and easily conceivable by a person skilled in the art shall not be viewed as departing from the scope of protection of the invention.

What is claimed is:

1. A shielding and insulating module with a shielding-assisting component, comprising:
an insertion connection insulating component provided therein with a butt-jointing space, the butt-jointing space being used to receive a portion of an electrical connector; and
a shielding-assisting component located at a bottom portion of the insertion connection insulating component, wherein the shielding-assisting component at least includes a main body portion, and the main body portion extends in a transverse-axis or longitudinal-axis direction.

2. The shielding and insulating module of claim 1, wherein a horizontal height of a bottom surface of the main body portion is lower than a horizontal height of a bottom surface of a main portion of the insertion connection insulating component.

3. The shielding and insulating module of claim 1, wherein the shielding-assisting component is connected to and positioned on the insertion connection insulating component.

4. The shielding and insulating module of claim 1, wherein the insertion connection insulating component is provided therein with a main beam member adjacent to the bottom portion of the insertion connection insulating component, the main beam member extends in the transverse-axis or longitudinal-axis direction, and a bottom surface of the main beam member lies against a top surface of the main body portion.

5. The shielding and insulating module of claim 4, wherein the shielding-assisting component is provided with at least one shielding-assisting component engaging component, and the shielding-assisting component engaging component is engaged with the main beam member.

6. The shielding and insulating module of claim 4, wherein the main body portion has two opposite lateral sides each provided with at least one clamping portion, and each said clamping portion is bent and lies against a lateral surface of the main beam member.

7. The shielding and insulating module of claim 4, wherein the main beam member has two opposite lateral sides each provided with at least one spacer, and an extending direction of the spacers is different from the extending direction of the main beam member.

8. The shielding and insulating module of claim 7, wherein the shielding-assisting component is further provided with at least one rib portion, an extending direction of the rib portion is different from the extending direction of the main body portion, and a top portion of the rib portion is engaged in a corresponding said spacer.

9. The shielding and insulating module of claim 8, wherein the shielding-assisting component is further provided with at least one contact portion, and each said contact portion is used to abut against a shielding frame of the electrical connector.

10. The shielding and insulating module of claim 9, wherein the rib portion is provided with a plurality of said contact portions, at least two said contact portions are each located on one of opposite lateral sides of the rib portion, and each said contact portion is used to abut against a different said shielding frame of the electrical connector.

11. The shielding and insulating module of claim 1, further comprising a board-end insertion connection frame, the board-end insertion connection frame allowing the insertion connection insulating component to be mounted in the board-end insertion connection frame.

12. The shielding and insulating module of claim 11, wherein the shielding-assisting component is connected to and positioned on the board-end insertion connection frame.

13. The shielding and insulating module of claim 1, wherein the shielding-assisting component is further provided with at least one rib portion, and an extending direction of the rib portion is different from the extending direction of the main body portion.

14. The shielding and insulating module of claim 13, wherein the rib portion is provided with a plurality of contact portions, at least two said contact portions are each located on one of opposite lateral sides of the rib portion, and each said contact portion is used to abut against a different shielding frame of the electrical connector.

15. A shielding and insulating module with a shielding-assisting component, comprising:
an insertion connection insulating component provided therein with a butt-jointing space, the butt-jointing space being used to receive a portion of an electrical connector; and
a shielding-assisting component located at a bottom portion of the insertion connection insulating component, wherein the shielding-assisting component at least includes a rib portion, and the rib portion is used to extend into a frame-separating passage between two adjacent shielding frames of the electrical connector.

16. The shielding and insulating module of claim 15, wherein the shielding-assisting component is provided with at least one shielding-assisting component engaging component, and the shielding-assisting component engaging component is engaged with the insertion connection insulating component.

17. The shielding and insulating module of claim 15, wherein the shielding-assisting component further includes a main body portion, the main body portion extends in a transverse-axis or longitudinal-axis direction and is connected to each said rib portion, and an extending direction of the main body portion is different from an extending direction of each said rib portion.

18. The shielding and insulating module of claim 17, wherein a horizontal height of a bottom surface of the main body portion is lower than a horizontal height of a bottom surface of a main portion of the insertion connection insulating component.

19. The shielding and insulating module of claim 17, wherein the insertion connection insulating component is provided therein with a main beam member adjacent to the bottom portion of the insertion connection insulating component, the main beam member extends in the transverse-axis or longitudinal-axis direction, and a bottom surface of the main beam member lies against a top surface of the main body portion.
